(19) United States
(12) Patent Application Publication
(10) Pub. No.: US 2024/0009750 A1
(43) Pub. Date: Jan. 11, 2024

(54) METHODS AND SYSTEMS FOR POWERING AND/OR CHARGING AUXILIARY SYSTEMS ON VEHICLES

(71) Applicant: Vanair Manufacturing, Inc., Michigan City, IN (US)

(72) Inventors: Ralph Kokot, Crown Point, IN (US); Kai Justice, Wheatfield, IN (US); Donnie Stone, LaPorte, IN (US)

(21) Appl. No.: 18/348,516

(22) Filed: Jul. 7, 2023

Related U.S. Application Data
(60) Provisional application No. 63/367,887, filed on Jul. 7, 2022.

(51) Int. Cl. B23K 9/10

(52) U.S. Cl. CPC B23K 9/1075; B60L 1/003

(57) ABSTRACT

Methods and systems for powering and/or charging auxiliary systems of a vehicle. Such methods and systems utilize a welding system having power conversion circuitry that receives power from at least a first power source on the vehicle and generates different output powers of the welding system characterized by different output voltages. At least two different auxiliary systems receive at least two of the different output powers of the welding system.

### CROSS-REFERENCE TO RELATED APPLICATIONS

This application claims the benefit of U.S. Provisional Application No. 63/367,887 filed Jul. 7, 2022, the contents of which are incorporated herein by reference.

### BACKGROUND OF THE INVENTION

The present invention generally relates to methods and systems for powering and/or charging auxiliary systems on vehicles. The invention particularly relates to methods and systems that utilize a welding system to provide power to auxiliary systems of vehicles.

Welding systems of types capable of being mounted to or used in combination with various mobile service, municipal, utility, maintenance, construction, repair, pipeline, and military vehicles (hereinafter, “vehicle(s)”) have been adapted to not only perform welding operations, but also to charge and jumpstart low-energy (typically lead acid) batteries of less than 30 volts. Such welding systems can be designed to control electrical wave form and voltage/amperage and finely tuned to hold constant voltage and constant current characteristics.

Welding systems of types described above typically receive power from a generator driven by an engine, and may incorporate one or more belt-driven auxiliary systems, such as a hydraulic pump or air compressor. However, the inclusion of a belt to drive an auxiliary system can consume significant horsepower from relative low horsepower engines often used to produce the power for welding, with the result of limiting other functions of the vehicle, reducing fuel economy, and interfering with the completion of jobs due to lack of available horsepower and torque. This is especially true at higher ambient temperatures and elevations where air density reduces the output power capability of an engine-driven welding system. Current methods of charging and jumpstarting 12V battery systems lack the power density and longevity to effectively run high-output hydraulic pumps, heating, ventilation, and air conditioning (HVAC) systems, and other auxiliary equipment.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods and systems that utilize a welding system to provide power to auxiliary systems of vehicles, including but not limited to service, municipal, utility, maintenance, construction, repair, pipeline, and military vehicles.

According to a nonlimiting aspect, such a system is installed on a vehicle and includes a welding system that comprises power conversion circuitry that receives power from at least a first power source on the vehicle and generates different output powers of the welding system characterized by different output voltages. At least two different auxiliary systems receive at least two of the different output powers of the welding system.

According to another nonlimiting aspect, a method includes providing a welding system installed on a vehicle, wherein the welding system comprises power conversion circuitry configured to receive power from at least a first power source on the vehicle and to generate different output powers corresponding to at least a welding mode of the welding system and at least a first ranged output mode of the welding system. The welding system is switched from the welding mode to the first ranged output mode to power an auxiliary system of the vehicle or maintain a high-voltage storage battery above 30 volts.

According to yet another nonlimiting aspect, a welding system installed on a vehicle includes power conversion circuitry configured to receive power from at least a first power source on the vehicle and to generate different output powers corresponding to at least a welding mode of the welding system and at least a first ranged output mode of the welding system.

Technical effects of systems and methods as described above preferably include the capability of a welding system to supply power to auxiliary systems on a vehicle in addition to its use for welding. Such uses may include supplying power to auxiliary systems at a fixed or fluctuating voltage, as nonlimiting examples, to power hydraulic pumps, electric-over-hydraulic systems, and HVAC systems, and to charge high-voltage storage batteries at voltages exceeding 30 volts and preferably above 48 volts.

These and other aspects, arrangements, features, and/or technical effects will become apparent upon detailed inspection of the figures and the following description.

### BRIEF DESCRIPTION OF THE DRAWINGS

FIG. 1 is a power diagram of a system equipped with a welding system configured to power a welder and other auxiliary systems according to certain nonlimiting aspects of the invention.

FIG. 2 is a schematic representation showing the system of FIG. 1 installed on a vehicle and the welding system operable to power a welder and other auxiliary systems on the vehicle.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Although the invention will be described hereinafter in reference to a mobile automotive platform in the form of a vehicle shown in the drawings, it will be appreciated that the teachings of the invention are also generally applicable to other types of applications, such as, but not limited to, sleds, trailers, railroad vehicles or cars, ships, and other mobile platform, as well as to non-mobile platforms.

Modern welding systems can be designed to control electrical wave form and voltage/amperage and finely tuned to hold constant voltage and constant current characteristics. Welding systems of the present invention incorporate additional circuitry and control logic that enable power control for uses other than welding. These uses include but are not limited to powering auxiliary systems at a fixed or fluctuating voltage for motor control or inverter power, enabling the powering of auxiliary systems including but not limited to hydraulic pumps, air compressors, and heating, ventilation, and air conditioning (HVAC) systems, and also enabling the charging of voltage storage batteries above 30 volts and preferably at or above 48 volts.

Typically, auxiliary systems and components on a vehicle, such as HVAC systems, electric-over-hydraulic systems, and rechargeable lithium-ion batteries, operate separately in that they do not electrically work together and are not designed to communicate and work together. However, preferred welding systems of the invention include power conversion circuitry and a welding control system that allow the welding system to be used to selectively power auxiliary systems in a multifunction package, such as a vehicle, at elevated voltages, such as above 30 volts and preferably at or above 48 volts. Further, the welding system may be used to charge lithium-ion batteries at such voltages.

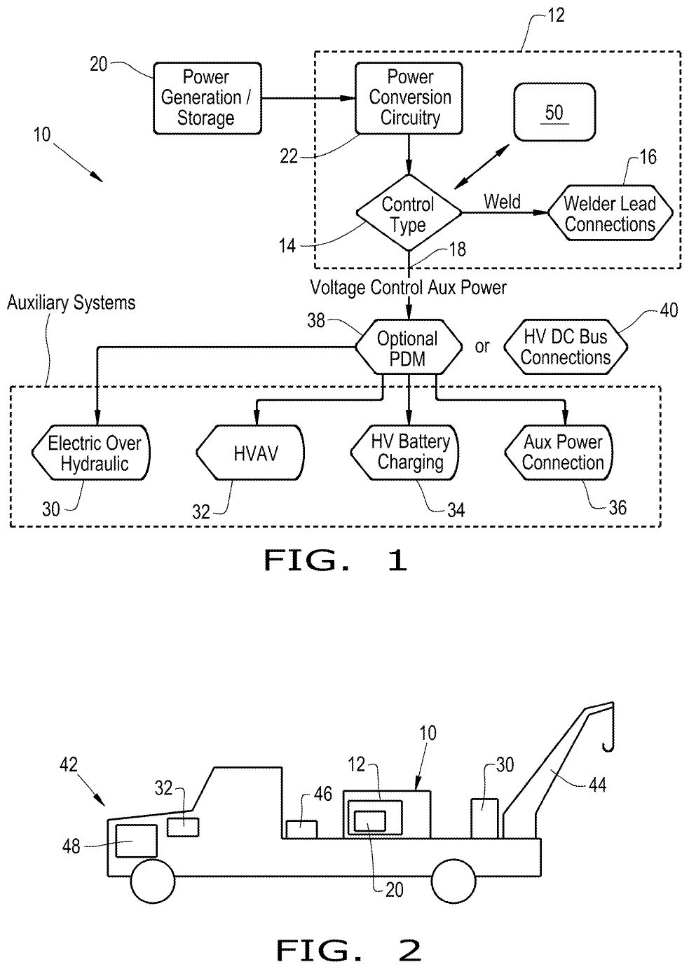

Turning now to the drawings, FIG. 1 shows a diagram of a system 10 configured to provide electrical power to various auxiliary systems according to certain exemplary aspects of the invention. The system 10 includes a welding system 12 having a welding control system 14 that allows the welding system 12 to be used as a welder to perform welding operations with welder lead connections 16 and also to provide auxiliary electric power to one or more auxiliary power couplings 18 through which power can be delivered to one or more auxiliary systems 30, 32, 34, and/or 36. The system 10 may be mounted to a mobile platform, such as a vehicle 42 represented in FIG. 2, so as to be easily moved to and from job sites and used at the job sites. As such, the following discussion will refer to the system 10 represented in FIG. 1 and a nonlimiting example of an installation of the system 10 as schematically represented in FIG. 2.

The system 10 includes at least one power source 20 that stores or generates electrical power for the welding system 12. The power source 20 may include an engine installed on the vehicle 42 that is separate from an engine 48 that is used as part of the vehicle's powertrain. The power source 20 may alternatively or additionally include an auxiliary DC battery, a traction battery, or any other source capable of supplying suitable electrical power to the welding system 12. The power source 20 may be incorporated as part of the welding system 12 or may be physically separate from but operatively connected to the welding system 12 so as to provide the necessary electrical power to the welding system 12.

The welding system 12 includes power conversion circuitry 22 configured to convert electrical current generated by the power source 20 into a form suitable for powering the welder lead connections 16 for welding. The welding control system 14 includes circuitry configured to selectively distribute electrical power from the power conversion circuitry 22 between the welder lead connections 16 and the auxiliary power coupling(s) 18. The welding control system 14 may be configured to alternatively switch between distributing power to either the welder lead connections 16 or the auxiliary power coupling(s) 18, or the welding control system 14 may be configured to provide distributed power to the welder lead connections 16 and the auxiliary power coupling(s) 18 at the same time. The welding control system 14 is configured to provide electrical power to the auxiliary power couplings (and thus to the various auxiliary systems 30, 32, 34, and/or 36) at one or more different controlled voltages that are appropriate for the particular auxiliary systems 30, 32, 34, and 36 installed on the vehicle 42. In the nonlimiting embodiment represented in the drawings, the auxiliary systems 30, 32, 34, and 36 operatively connected to the system 10 include an electric-over-hydraulic system 30 for operating a crane 44, an HVAC system 32 for cooling a cab of the vehicle 42, a high-voltage battery charging system 34, and an auxiliary power connection 36, such as an electrical outlet or an electric power take-off (ePTO) system that may be used to provide auxiliary power to yet other devices associated or used with the vehicle 42. Optionally, a power distribution module (PDM) 38 may be used to control and distribute the auxiliary electric power received from the system 10 between the various auxiliary systems 30, 32, 34, and 36. The PDM 38 is electrically coupled to the auxiliary power coupling 18 of the welding system 12, and the various auxiliary systems 30, 32, 34, and 36 are electrically coupled to the PDM 38. In an alternative arrangement, one or more high-voltage DC bus connections 40 may directly connect the auxiliary system 30, 32, 34, and 36 to one or more respective auxiliary power coupling(s) 18.

The welding system 12 according to some aspects of the invention may utilize circuitry and logic for power control and diversion between different outputs. These outputs are used to power the auxiliar systems 30, 32, 34, and 36. The system 10 can be used in conjunction with the vehicle 42 and its engine 48 for purposes of anti-idling/hybridization of the work platform, increasing horsepower capability, and ultimately increasing functionality of the vehicle 42 and its various systems. The system 10 can optionally be used on a hybrid or fully electric vehicle and powered via an auxiliary DC battery or traction battery. When the welding system 12 is not being used for welding and is controlled to power an auxiliary system 30, 32, 34, or 36, the welding system 12 can output a controlled voltage in a constant voltage (CV) mode to provide a steady voltage to power the auxiliary system. When the power source 20 is or includes a battery, the welding system 12 can output constant current (CC) as the battery is already a constant voltage device in the system 10. The welding system 12 may be configured to communicate with a battery used as a power source 20 and the auxiliary systems 30, 32, 34, and 36 to understand how much power it should output to the auxiliary systems 30, 32, 34, and 36.

According to preferred aspects of the invention, the system 10 is provided on a vehicle 42 for operating one or more vehicle-mounted auxiliary systems 30, 32, 34, and 36 using the welding system 12. In FIG. 2, the vehicle 42 (such as a mobile service, municipal, utility, or military vehicle) is equipped with the system 10 and the welding system 12 thereof, and is further equipped with an HVAC system 32, an electric-over-hydraulic system 30, a hydraulic crane 44 powered by the electric-over-hydraulic system and a storage battery 46 mounted to the vehicle 42 as auxiliary systems. The system includes an engine 20 as the power source 20 for supplying power to drive the welding system 12. In one example, an operator drives the vehicle 42 to a jobsite and activates the system 10 while the vehicle engine 48 idles at a job site. At some point, the engine 48 turns off, such as when the vehicle 42 senses that the engine 48 has been idling for a predetermined time. After the engine 48 turns off, the auxiliary HVAC system 32 turns on to keep the vehicle cab at a comfortable temperature for the operator. When a user attempts to use the crane 44, the electric-over-hydraulic system 30 turns on and operates, which causes the battery 46 to begin to deplete. To prevent the battery 46 from depleting, the engine 20 of the system 10 begins to operate such that the welding system 12 starts charging the battery 46 while also continuing to power the electric-over-hydraulic system and the auxiliary HVAC system 32. When the user stops using the crane 44, the electric-over-hydraulic system 30 turns off. Thereafter, when the battery 46 is fully charged, the system 10 turns off.

In some embodiments, the welding control system 14 includes control logic over the system 10. The welding control system 14 may further include a module or controller that conducts load priority over the entire system or parts of the system 10.

The system 10 may include a human-machine interface (HMI) 50 configured to allow interface, selection, and/or automation for priority between power supplied for welding and to the auxiliary systems (e.g., 30, 32, 34, and/or 36) of the vehicle 42. The system 10 may be configured such that a plurality of auxiliary systems (e.g., 30, 32, 34, and/or 36) can communicate with the HMI 50 to share load/status information, safety, and/or fault related data with the HMI 50.

Preferred embodiments of the system 10 are configured to provide an output voltage of 20 volts or more and 5 kilowatts (KW) of power. The power conversion circuitry 22 of the system 10 is preferably configured to handle, that is, to receive, process, and/or deliver, 5 KW of power or more. The system 10 powers the electric-over-hydraulic system 30 so as to provide a minimum of 5 gallons per minute (GPM) at 1500 pounds per square inch (PSI). The power source 20 of the system 10 may be an engine, and/or include a DC battery capable of at least 5 kilowatts of output above 20 volts, a fuel cell DC power source capable of at least 5 kilowatts of output above 20 volts, and/or an AC power source capable of at least 5 kilowatts of output above 20 volts.

The system 10 may include electrical circuitry to isolate welding power connections from welding auxiliary output power connections used for powering an auxiliary system. The electrical circuitry may be incorporated as part of the welding control system 14, for example.

A nonlimiting example of a use of the system 10 involves the ability to switch the welding control system 14 between a welding mode configured to provide appropriate welding power to the welder lead connections 16 and one or more ranged output modes configured to power one or more of the auxiliary systems 30, 32, and/or 36 via the auxiliary power coupling(s) 18. Such a switching capability may utilize the aforementioned optional HMI 50. Preferably, in the ranged output mode, the system 10 is also configured to maintain, that is to charge, one or more high-voltage storage batteries 34 of at least 30 volts and preferably higher. The auxiliary systems 30, 32, and/or 36 powered by the ranged output mode may include, for example the electric-over-hydraulic system 30 and/or the vehicle's HVAC system 32, and/or other types of auxiliary systems as described herein.

The welding system 12 may be configured to provide multistage charge energy for a storage battery 46 of 48 volts or higher. The welding system 12 may further include circuitry configured to communicate with a battery management system (BMS) of the storage battery 46 to determine a charge profile characteristic of the storage battery 46.

The welding system 12 may include circuitry configured to automatically start and/or stop the welding system 12 in response to input from one or more of the auxiliary systems 30, 32, 34, and/or 36, such as auxiliary power demand, low voltage battery charge levels, and higher voltage power battery charge levels.

As previously noted above, though the foregoing detailed description describes certain aspects of one or more particular embodiments of the invention, alternatives could be adopted by one skilled in the art. For example, the system 10, welding system 12, auxiliar systems, and their components could differ in appearance and construction from the embodiments described herein and shown in the drawings, functions of certain components of the system 10 and/or welding system 12 could be performed by components of different construction but capable of a similar (though not necessarily equivalent) function, and various materials could be used in the fabrication of the system 10, welding system 12, and/or their components. As such, and again as was previously noted, it should be understood that the invention is not necessarily limited to any particular embodiment described herein or illustrated in the drawings.

1. A system installed on a vehicle, the system comprising:
a welding system comprising power conversion circuitry that receives power from at least a first power source on the vehicle and generates different output powers of the welding system characterized by different output voltages; and
at least two different auxiliary systems that receive at least two of the different output powers of the welding system.

2. The system of claim 1, wherein the first power source on the vehicle is an engine installed on the vehicle that is separate from an engine used in a powertrain of the vehicle.

3. The system of claim 1, wherein the first power source on the vehicle comprises a DC battery source capable of at least 5 kilowatts of output above 20 volts.

4. The system of claim 1, wherein the first power source on the vehicle comprises a fuel cell-powered DC source capable of at least 5 kilowatts of output above 20 volts.

5. The system of claim 1, wherein the first power source on the vehicle comprises an AC power source capable of at least 5 kilowatts of output above 20 volts.

6. The system of claim 1, wherein the power conversion circuitry is adapted to receive power from at least a second power source on the vehicle.

7. The system of claim 1, wherein the at least two different auxiliary systems are chosen from the group consisting of battery charging systems, electric power take-off systems, electric-over-hydraulic systems, and heating, ventilation, and air conditioning (HVAC) systems.

8. The system of claim 1, wherein at least one of the output voltages is at least 20 volts.

9. The system of claim 1, wherein at least one of the power received by the power conversion circuitry and the different output powers generated by the power conversion circuitry is at least 5 kilowatts.

10. The system of claim 1, wherein the at least two different auxiliary systems comprise an electric power take-off system capable of a minimum of 5 gallons per minute at a pressure of 1500 pounds per square inch.

11. A method comprising:
providing a welding system installed on a vehicle, the welding system comprising power conversion circuitry configured to receive power from at least a first power source on the vehicle and to generate different output powers corresponding to at least a welding mode of the welding system and at least a first ranged output mode of the welding system; and
switching the welding system from the welding mode to the first ranged output mode to power an auxiliary system of the vehicle or maintain a high-voltage storage battery above 30 volts.

12. The method of claim 11, wherein the auxiliary system is chosen from the group consisting of battery charging systems, electric power take-off systems, electric-over-hydraulic systems, and heating, ventilation, and air conditioning (HVAC) systems.

13. A welding system installed on a vehicle, the welding system comprising power conversion circuitry configured to receive power from at least a first power source on the vehicle and to generate different output powers corresponding to at least a welding mode of the welding system and at least a first ranged output mode of the welding system.

14. The welding system of claim 13, wherein at least one of the different output voltages is at least 20 volts.

15. The welding system of claim 13, wherein at least one of the power received by the power conversion circuitry and the different output powers generated by the power conversion circuitry is at least 5 kilowatts.

16. The welding system of claim 13, the welding system further comprising a human-machine interface configured to allow interface, selection, and/or automation for priority between the welding mode, the first ranged output mode, and at least a second ranged output mode of the welding system.

17. The welding system of claim 16, wherein a plurality of auxiliary systems of the vehicle communicate with the human-machine interface to share load/status information, safety, and/or fault related data with the human-machine interface.

18. The welding system of claim 13, wherein the first ranged output mode supplies multistage charge energy for a storage battery of the vehicle that has a capacity of 48 volts or higher.

19. The welding system of claim 18, wherein the welding system further comprises circuitry that communicates with a battery management system (BMS) of the storage battery to determine a charge profile characteristic of the storage battery.

20. The welding system of claim 13, wherein the welding system further comprises a welder and circuitry that automatically starts and stops the welder in response to at least one of auxiliary power demand, low voltage battery charge levels, and higher voltage power battery charge levels of the vehicle.
